(19) United States
(12) Patent Application Publication
(10) Pub. No.: US 2006/0241996 A1
(43) Pub. Date: Oct. 26, 2006

(54) Method, system and program product for monitoring work items

(75) Inventors: Ernest J. Burger, Highland, NY (US); Maria T. Kapogiannis, Poughkeepsie, NY (US); Andrew C. Stafford, Rocky River, OH (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/110,408

(22) Filed: Apr. 20, 2005

(51) Int. Cl. G06F 9/46

(52) U.S. Cl. 705/9

(57) ABSTRACT

Under the present invention queues are associated with each of a set (e.g., one or more) of work lists of work items to be monitored. Work items that are desired to be monitored are designated by selecting the users assigned thereto. In so selecting, the present invention allows all users to be selected in which case all work items will be monitored, or individual users to be selected in which case only the work items assigned thereto will be monitored. In any event, the designated work items are then monitored according to a predefined schedule for any changes in state (e.g., change in status, change in priority, change in assignment, etc.). The monitored states are then stored in the associated queues, and electronic messages are sent to the assigned users based on those stored states.

### FIELD OF THE INVENTION

In general, the present invention relates to work list management. Specifically, the present invention provides a method, system and program product for monitoring (changes in state of) work items.

### BACKGROUND OF THE INVENTION

In business, it is common for projects to be divided into individual work items or tasks (e.g., manual or computer-based tasks) that are each assigned to one or more individuals. The work items for a particular project can be realized as a work list. Various “workflow” software packages for maintaining such work lists currently exist. One example of such a program is MQSeries Workflow, which is commercially available from International Business Machines Corp. of Armonk, N.Y. In MQSeries Workflow, work lists can be established and the work items thereof can be assigned to individuals. The work items can typically be assigned differing priorities. For example, a work item of particularly high importance can be marked as “critical.” Moreover, as time passes, any changes in state of the work items can be indicated. For example, when a work item is completed, it can be indicated as having been completed and/or it can be removed from its work list.

Unfortunately, the only way an individual currently has to monitor the state of work items is to log into his/her workflow program where the work items are maintained. Thus, there is no way for an individual to know if a work item has been disabled, or another individual was assigned to it until the individual logs into the workflow program. That is, existing workflow programs fail to leverage existing messaging technology such as electronic mail programs to monitor and provide notification to individuals.

In view of the foregoing, there exists a need for a method, system and program product for monitoring work items. Specifically, a need exists for a system that is capable of monitoring changes in state of work items in a workflow program, and is capable of utilizing existing messaging programs to provide corresponding notifications/messages.

### SUMMARY OF THE INVENTION

In general, the present invention provides a method, system and program product for monitoring work items. Specifically, under the present invention queues are associated with each of a set (e.g., one or more) of work lists of work items to be monitored. Work items that are desired to be monitored are designated by selecting the users assigned thereto. In so selecting, the present invention allows all users to be selected in which case all work items will be monitored, or individual users to be selected in which case only the work items assigned thereto will be monitored. In any event, the designated work items are then monitored according to a predefined schedule for any changes in state (e.g., change in status, change in priority, change in assignment, etc.). The monitored states are then stored in the associated queues, and electronic messages are sent to the assigned users based on those stored states.

A first aspect of the present invention provides a method for monitoring work items, comprising: associating a queue with each of a set of work lists of work items to be monitored; monitoring changes in state of the work items according to a predefined configuration; storing states of the work items in the associated queues based on the monitoring; and sending electronic messages to users assigned to the work items based on the states stored in the queues and the predefined configuration.

A second aspect of the present invention provides a computer-implemented method for monitoring work items, comprising: associating a queue with each of a set of work lists of work items to be monitored; designating work items to be monitored by selecting users assigned to the work items; monitoring changes in state of the work items according to at least one predefined schedule; storing states of the work items in the associated queues based on the monitoring; and sending electronic messages to users assigned to the work items based on the states stored in the queues.

A third aspect of the present invention provides a system for monitoring work items, comprising: a queue association system for associating a queue with each of a set of work lists of work items to be monitored; a user selection system for designating work items to be monitored by selecting users assigned to the work items; a monitoring system for monitoring changes in state of the work items according to at least one predefined schedule; a state storage system for storing states of the work items in the associated queues based on the monitoring; and a messaging system for sending electronic messages to users assigned to the work items based on the states stored in the queues.

A fourth aspect of the present invention provides a program product stored on a computer readable medium for monitoring work items, the computer readable medium comprising program code for performing the following steps: associating a queue with each of a set of work lists of work items to be monitored; designating work items to be monitored by selecting users assigned to the work items; monitoring changes in state of the work items according to at least one predefined schedule; storing states of the work items in the associated queues based on the monitoring; and sending electronic messages to users assigned to the work items based on the states stored in the queues.

A fifth aspect of the present invention provides a method for deploying an application for monitoring work items, comprising: providing a computer infrastructure being operable to: associate a queue with each of a set of work lists of work items to be monitored; designate work items to be monitored by selecting users assigned to the work items; monitor changes in state of the work items according to at least one predefined schedule; store states of the work items in the associated queues based on the monitoring; and send electronic messages to users assigned to the work items based on the states stored in the queues.

A sixth aspect of the present invention provides computer software embodied in a propagated signal for monitoring work items, the computer software comprising instructions for causing a computer system to perform the following functions: associate a queue with each of a set of work lists of work items to be monitored; designate work items to be monitored by selecting users assigned to the work items; monitor changes in state of the work items according to at least one predefined schedule; store states of the work items in the associated queues based on the monitoring; and send electronic messages to users assigned to the work items based on the states stored in the queues.

A seventh aspect of the present invention provides a business method for monitoring work items.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for monitoring work items according to the present invention.

FIG. 2 shows an illustrative interface for creating a work list according to the present invention.

FIG. 3 shows an illustrative interface when selecting all users according to the present invention.

FIG. 4 shows the illustrative interface of FIG. 3 when selecting individual users according to the present invention.

FIG. 5 shows an illustrative interface for creating a message data structure according to the present invention.

FIG. 6 shows a method flow diagram according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### BEST MODE FOR CARRYING OUT THE INVENTION

As indicated above, the present invention provides a method, system and program product for monitoring work items. Specifically, under the present invention queues are associated with each of a set (e.g., one or more) of work lists of work items to be monitored. Work items that are desired to be monitored are designated by selecting the users assigned thereto. In so selecting, the present invention allows all users to be selected in which case all work items will be monitored, or individual users to be selected, in which case only the work items assigned thereto will be monitored. In any event, the designated work items are then monitored according to a predefined schedule for any changes in state (e.g., change in status, change in priority, change in assignment, etc.). The monitored states are then stored in the associated queues, and electronic messages are sent to the assigned users based on those stored states.

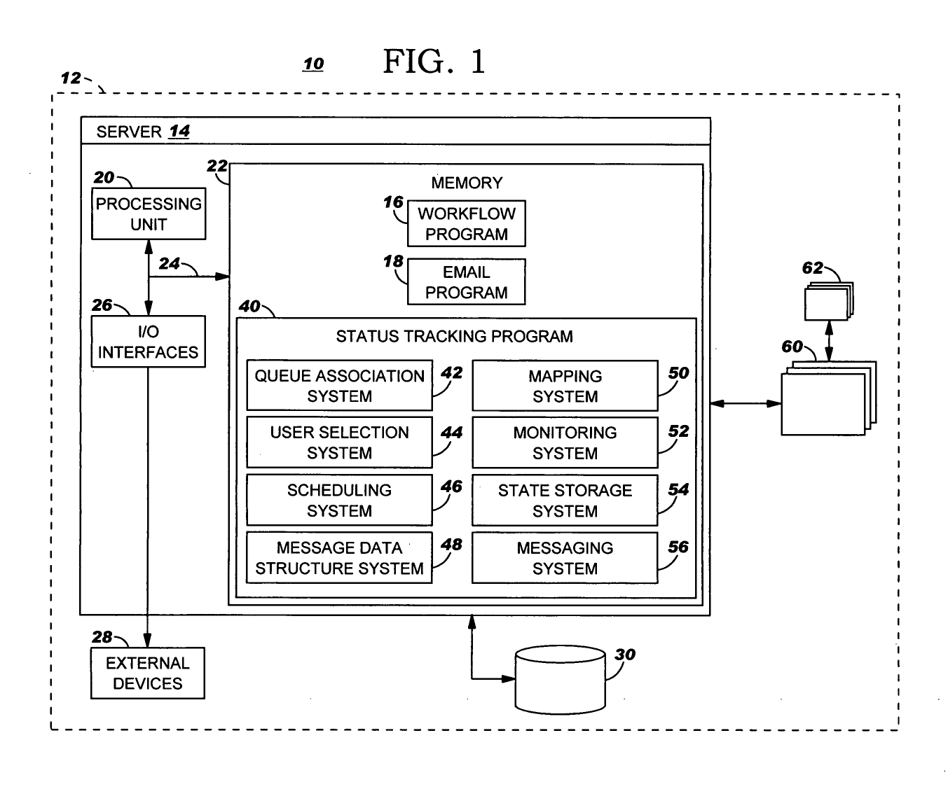

Referring now to FIG. 1, a system 10 for monitoring work items according to the present invention is shown. As used herein, the term “work item” is intended to mean any task, computer-based or manual, that is assigned to a user 62 to be performed. The term “work list” is intended to mean any collection of work items. In a typical embodiment, a work list corresponds to a project to be performed. Moreover, in a typical embodiment, the term “electronic message” means an email message sent using email program 18. However, under the present invention, electronic message can also mean an instant message, a short message or the like. In such cases, email program 18 can be replaced by or supplemented with corresponding messaging programs.

As depicted, system 10 includes a computer infrastructure 12, which comprises a server 14 in communication with clients 60. Server 14 and clients 60 are intended to represent any type of computer systems capable of carrying out the teachings of the present invention. Examples include a laptop computer, a desktop computer, a workstation, a handheld device. In addition, as will be further described below, server 14 and/or clients 60 can be deployed and/or operated by a service provider that is monitoring work items for an organization.

Server 14 and clients 60 typically communicate over a network (e.g., the Internet, a wide area network (WAN), a local area network (LAN), a virtual private network (VPN), etc. As such communications between server 14 and clients 60 can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet.

Shown implemented on server 14 is status tracking program 40. As will be further described below, status tracking program 40 will leverage workflow program 16 (e.g., MQSeries Workflow) and electronic message (email) program 18 (e.g., Lotus Notes) to monitor work items, and provide corresponding electronic notifications/messages to users 62. It should be understood in advance that although status tracking program 40, workflow program 16 and email program 18 are implemented on a common computer system, this need not be the case. For example, status tracking program 40 could be implemented on a separate computer system (not shown) from workflow program 16. Such a separate computer system may or may not be part of computer infrastructure 12. If implemented on a separate computer system, status tracking system 40 would communicate with the computer system(s) (e.g., server 14) on which workflow program 16 is loaded.

In any event, server 14 is shown including a processing unit 20, a memory 22, a bus 24, and an input/output (I/O) interfaces 26. Further, computer system 14 is shown in communication with external I/O devices/resources 28 and one or more storage systems 30. In general, processing unit 20 executes computer program code, such as status tracking system 40, which is stored in memory 22 and/or storage system(s) 30. While executing computer program code, processing unit 20 can read and/or write data, to/from memory 22, storage system(s) 30, and/or I/O interfaces 26. Bus 24 provides a communication link between each of the components in server 14. External devices 28 can comprise any devices (e.g., keyboard, pointing device, display, etc.) that enables a user to interact with server 14 and/or any devices (e.g., network card, modem, etc.) that enables server 14 to communicate with one or more other computing devices, such as client 60.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the various process steps of the invention. Moreover, server 14 is only representative of various possible computer infrastructures that can include numerous combinations of hardware. To this extent, in other embodiments, server 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more external devices 28. Still further, it is understood that one or more additional components (e.g., system software, math co-processing unit, etc.) not shown in FIG. 1 can be included in server 14. However, if server 14 comprises a handheld device or the like, it is understood that one or more external devices 28 (e.g., a display) and/or storage system(s) 30 could be contained within server 14, not externally as shown.

Storage system 30 can be any type of system (e.g., a database) capable of providing storage for information under the present invention. Such information can include, for example, work lists of work items, predefined schedules/configurations for carrying out the present invention, etc. To this extent, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). Although not shown, additional components, such as cache memory, communication systems, system software, etc., may be incorporated into server 14. Moreover, although not shown for brevity purposes, clients 60 operated by users 62 will likely contain computerized components similar to server 14.

Shown in memory 22 of server 14 is status tracking system 40, which includes queue association system 42, user selection system 44, scheduling system 46, message data structure system 48, mapping system 50, monitoring system 52, state storage system 54 and messaging system 56. Operation of each of these systems is discussed further below. However, it is understood that some of the various systems shown in FIG. 1 can be implemented independently, combined, and/or stored in memory for one or more separate computers systems that communicate over a network. Further, it is understood that some of the systems/functionality may not be implemented and/or additional systems/functionality may be included as part of the present invention. Still yet, it is understood that the depiction of these systems shown in FIG. 1 is illustrative only and that the same functionality could be achieved with a different configuration. That is, the functionality of these systems could be combined into fewer systems, or broken down into additional systems.

Under the present invention, status tracking system 40 will be used to monitor a status of work items, and provide corresponding electronic notification/messages to users 62 assigned thereto. Before this functionality is described in greater detail, a brief description of workflow program 16 will be given. In general, workflow program 16 is intended to represent any type of workflow program in which work lists of work items can be established, and assigned to one or more users 62. One example of such a program is MSeries Workflow.

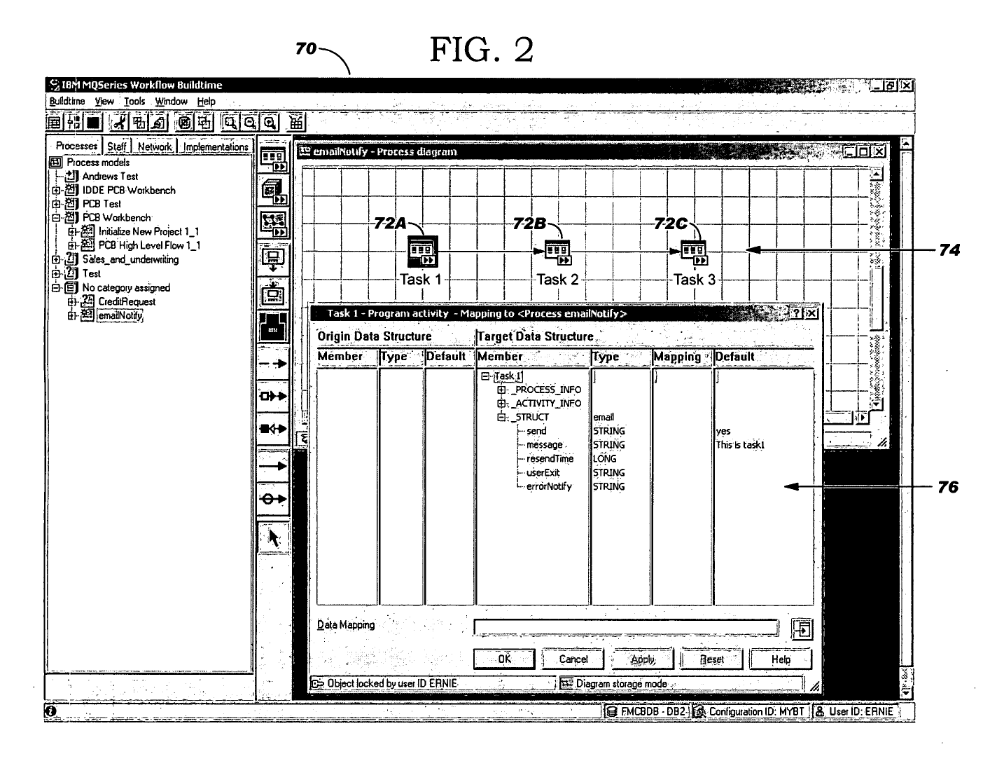

Referring to FIG. 2, an illustrative interface 70 according to the present invention is shown. Interface 70 represents one interface that could be provided by workflow program 16 as modified according to the present invention. As depicted, work items 72A-C for a project can be grouped/connected into a work 74. Each of these work items 72A-C can be assigned to one or more users 62 (FIG. 1) to be performed. Moreover, each of these work items 72A-C is separately (or collectively) configurable. That is, each can have its own condition, priority, etc. The concept of configuring work items 72A-C for monitoring and sending electronic messages under the present invention is referred to as providing a “predefined configuration.” Configuration values 76 for work item 72A are depicted in FIG. 2. Shown below is a more complete listing of illustrative configuration values that could be implemented according to the present invention. It should be understood that these configuration values could be set for work items 72A-C using status tracking program 40 (or its sub-systems) shown in FIG. 1, or they could be separately provided in one or more configuration files (e.g., .ini files) or the like.

SEND=(yes/no)

Whether an electronic message should or should not be sent (yes/no) for a work item.

EMAIL_FROM=notifier@us.ibm.com

The electronic message address used in the “from” field of the sent message.

RESEND_TIME=1440

The amount of time until the next time an electronic message will be sent for an activity.

RESEND_UNITS=(Minutes/Hours/Days)

The base units used to calculate the RESEND_TIME value in.

DEFAULT_EMAIL=default@us.ibm.com

The address to be used if a defined email address is not mapped to a userid.

REFRESH_TIME=15

The amount of time between refreshing the items in the work list (i.e., the amount of time between monitoring operations for the work item).

DOMAIN=us.ibm.com

This is the name of the mail server domain.

MAX_SEND_COUNT=5

This is the max number of electronic messages to send to a user 62 for a work item. Note, that once the MAX_SEND_COUNT is reached, electronic messages will be sent to the ADMIN_NOTIFY for that work item, at a frequency equal to the RESEND_TIME, until the work item is cleared from the work list.

ADMIN_NOTIFY=admin@us.ibm.com

This is the electronic message address of the user 62 that will be notified if the MAX_SEND_COUNT has been exceeded for a work item.

WORKLIST=all; ready; disabled;

This is a semicolon “;” delimited list of valid work lists for the runtime database that will be monitored.

ERROR_NOTIFY=error_notifier@us.ibm.com

This is the electronic message address of the user 62 that will be notified in the event that an error occurred during the running of the emailNotify program. This should be the person responsible for starting/stopping and configuring the emailNotify program.

MESSAGE=This message sent by the email notify program

This can be a default message that is sent along with every email. Note, that the message field can be over ridden by the message field in the message data structure.

MAILSERVER=us.ibm.com

This is the name of the mailserver in infrastructure 12.

RESEND_UNITS=(Minutes/Hours/Days)

The base units used to calculate the RESEND_TIME value.

USER_EXIT=

A program implementation (defined in workflow) that could be executed along with sending an electronic message.

Referring back to FIG. 1, under the present invention, queue association system 42 will associate a queue with each work list that is established. Each queue stores a status of each work item of the corresponding work list associated therewith. Under the present invention, the term queue is meant in the generic sense. Specifically, the queues are not necessarily first-in first-out (FIFO) queues, but rather they could be random access queues whereby any item therein can be accessed (e.g., deleted) at any time. To this extent, in a typical embodiment, the queues are Java hashtables in which the statuses of corresponding work items are stored. Moreover, each work list is typically assigned its own distinct queue, although this need not be the case.

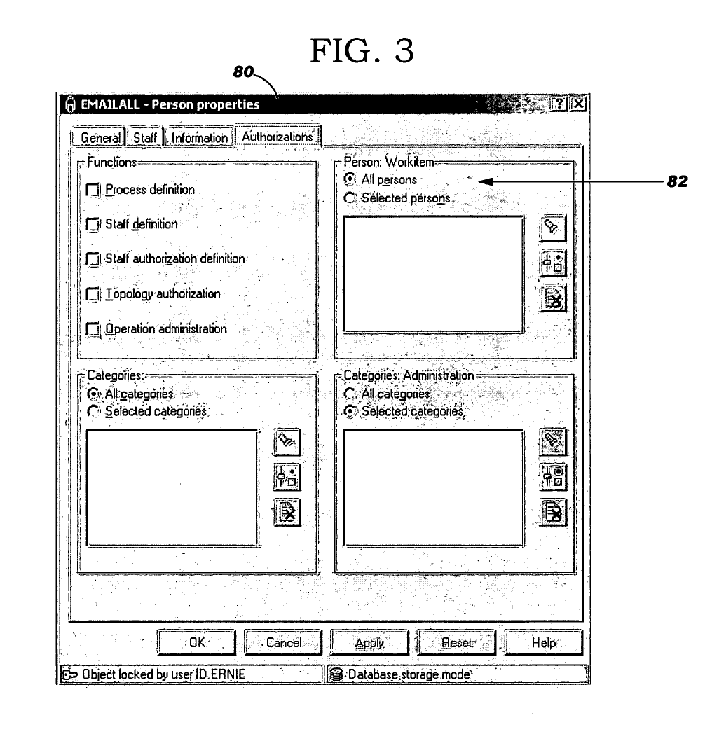

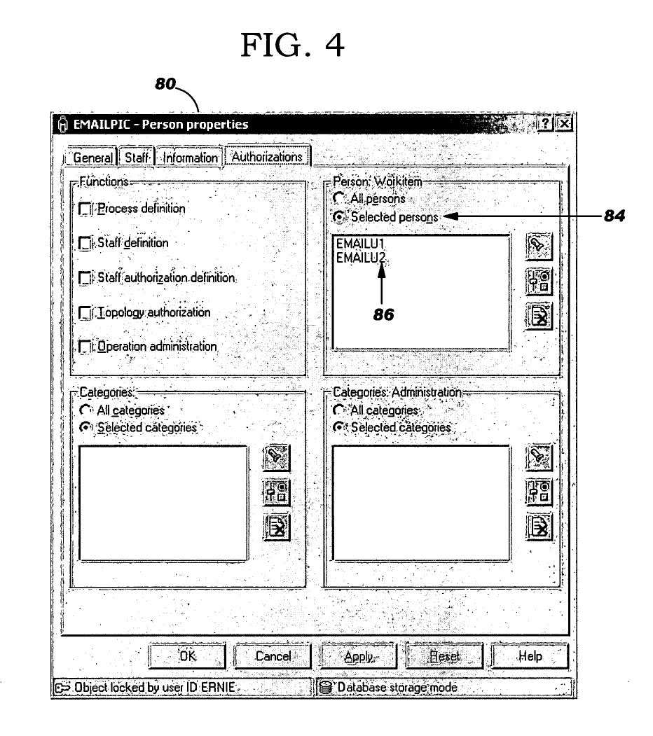

Once queues have been associated with the work lists, user selection system 44 can be used to designate whose work items are desired to be monitored. In a typical embodiment, work items are designated by selecting users 62. To this extent, all users 62 could be selected in which case all work items would be monitored, or individual users 62 could be selected in which case only the work items assigned to the selected users would be monitored. Referring to FIG. 3, an illustrative interface 80 for selecting users is shown. As shown, the “all persons” option 82 has been selected. This would cause all work items to be monitored. Referring to FIG. 4, interface 80 is shown in which the “selected persons” option 84 has been selected. This allows individual users 86 (e.g., emailuser 1 and emailuser 2) to be selected. In such a case, only the work items for those individual users will be monitored.

Referring back to FIG. 1, scheduling system 46 is provided for setting one or more predefined schedules for monitoring the designated work items. Specifically, scheduling system 46 can be used to individually set a time interval for monitoring each of the work items, and for sending corresponding electronic messages. This time interval is referred to as Refresh_Time in the above listing of configuration values. For example, scheduling system 46 could be used to indicate that the state of work item 72A should be monitored every fifteen minutes. It should be understood that scheduling system 46 is highly configurable so that schedules can be globally set for all work items 72A-C, or schedules can be individually set for separate work items 72A-C. Regardless, once the predefined schedule(s) have been set, a message data structure for the electronic messages can be provided using message data structure system 48. Although the configuration values shown above include a “Message” configuration value, such configuration value can be overridden by creating a message data structure. Since different work items 72A-C can have different configurations, the corresponding messages that are sent out can be individually tailored using message data structure system 48. In a typical embodiment, the message data structure that is created, is saved in a server database for workflow program 16.

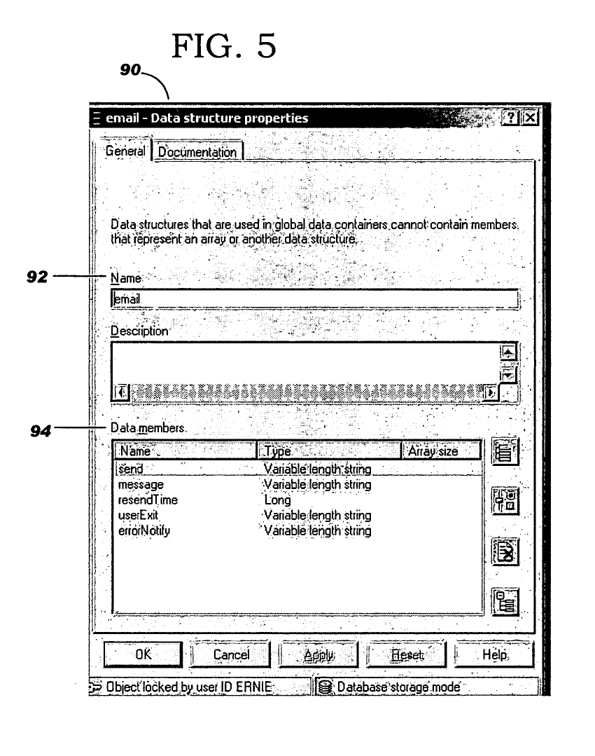

Referring to FIG. 5, an illustrative interface 90 for creating a message data structure according to the present invention is shown. In creating a message data structure, a name 92 will be provided, and data variables/members 94 will be designated. Once a message data structure is created for one or more work items, any electronic messages sent for those work items will be generated using that message data structure.

Referring back to FIG. 1, mapping system 50 is shown. In general, mapping system 50 allows a mapping of user identifications to user electronic message addresses to be provided. As indicated above, users can be individually selected to designate the work items that are to be monitored. This is typically accomplished by designating the user identifications for the selected users. However, when electronic messages are to be sent out to such users, electronic message addresses will be needed. Accordingly, mapping system 50 could be used to create such a mapping, or obtain such a mapping (e.g., from a previously created file). As shown in the above illustrative listing of configuration values, if a mapping for an electronic message address is not provided, then the Default_Email configuration value would be used.

At this point, monitoring system 52 can begin monitoring the designated work items for any changes in state thereof. Such changes could be any type change to work items. Example, include changes in status (e.g., completed), changes in priority (e.g., high priority), changes in user assignment (e.g., now assigned to user “B”), etc. Such changes could also include the addition of new work items, or the deletion of existing work items. In any event, as indicated above, when work items experienced changes of state prior to the present invention, the only way users 62 would become aware is to manually log into work flow program 16 to check for such changes.

The present invention alleviates this problem by leveraging workflow program 16 and email program 18 to automatically provide such notification to users 62. Specifically, monitoring program 52 is adapted to interface with workflow program 16 (according to the predefined schedule(s)) so that that any changes in state to designated work items will be detected. As monitoring system 52 monitors the work items, the states thereof will be stored by state storage system 54 in the corresponding queue. For example, assume that at time T0, work item “A” of work list “1” was assigned a priority of medium and assigned to user “D.” As indicated above, queue association system 42 would initially associate work list “1” with a queue (e.g., queue “1”). Further assume that status tracking program 40 had been configured to monitor work item “A” every 15 minutes. At time T1, upon commencing the monitoring of work item “A,” monitoring system 52 would detect this initial state configured for work item “A,” and state storage system 54 would store the same in queue “1.” Now assume that fifteen minutes later at time T2, monitoring system 52 monitored work item “A” again and detected that the priority thereof had been changed from “ready” to “active” since the previous monitoring operation (i.e., time T1). At this point, state storage system 54 would store this changed priority as a change of state in queue “1.”

Messaging system 56 would then be used to send electronic messages to the assigned user (e.g., user “D”) notifying him/her of the state change. In generating and sending such messages, messaging system 56 is configured to use the message data structure that was created for the work item. In addition, messaging system 56 can be used to designate one or more criterion for sending the electronic messages. For example, an administrator might only want electronic messages to be sent to the assigned user when certain state changes (e.g., changes in work item priority) are experienced. The configuration of messaging system 56 can provide this functionality. To this extent, a global configuration would be set for all work item messages, or individual configurations could be set for individual work item messages. Regardless, assume that messaging system 56 was configured to generate and send an electronic message to user “D” when a change in state for work item “A” was experienced. In this case, messaging system 56 would interface with email program 18 (and use the mapping) to generate and send the electronic message to user “D.” As shown above, the illustrative configuration values include Resend_Time, Max_Send_Count, Admin_Notify and Error_Notify. If a response (e.g., a read-receipt, a response message, etc.) to the electronic message is not received within the Resend_Time, a follow-up message could be sent. The Max_Send_Count sets forth the maximum number of electronic messages that should be sent for a single state change (including re-sends). If this value is exceeded, an electronic message could be sent to an administrator, manager or the like identified by the Admin_Notify value. In addition, if an error in the messaging process is noted, a notification message could be sent to the party identified by the Error_Notify value.

It should be understood that there are various ways for implementing the present invention. For example, separate instances of status tracking program 40 could be spawned for each work item or work list that is to be monitored. Alternatively, a single instance could be provided for all work items and work lists as described in the above example. In addition, as mentioned above, the configuration of status tracking program 40 to monitor work items and send electronic messages as described herein (e.g., setting schedules, creating message data structures, providing mappings, designating criteria for sending messages, defining the above-illustrative configuration values, etc.) can be referred to as providing a “predefined configuration(s)” under which the present invention can be carried out. Such predefined configuration(s) can be provided in one or more files (e.g., an .ini file(s)), storage system 30 or the like.

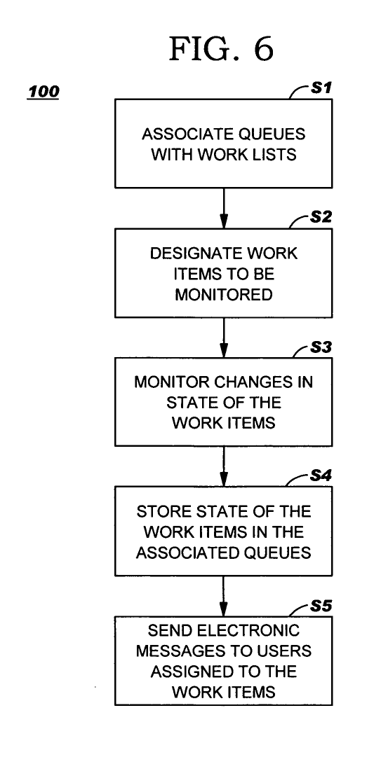

Referring to FIG. 6, a method flow diagram 100 according to the present invention is shown. In step S1, a queue is associated with each of a set of work lists of work items to be monitored. In step S2, work items to be monitored are designated by the selecting users assigned thereto. As mentioned above, all users could be selected, or individual user could be selected. In step S3, changes in state of the work items of the work items are monitored according to at least one predefined schedule. In step S4, states of the work items are stored in the associated queues based on the monitoring. In step S5, electronic messages are sent to users assigned to the work items based on the states stored in the queues.

While shown and described herein as a method and system for monitoring work items, it is understood that the invention further provides various alternative embodiments. For example, in one embodiment, the invention provides a computer-readable medium that includes computer program code to enable a computer infrastructure to monitor work items. To this extent, the computer-readable medium includes program code that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as an Internet Service Provider, could offer to monitor work items as described above. In this case, the service provider can create, maintain, support, etc., a computer infrastructure, such as computer infrastructure 12 (FIG. 1) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a method for monitoring work items. In this case, a computer infrastructure, such as computer infrastructure 12 (FIG. 1), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for monitoring work items, comprising:
associating a queue with each of a set of work lists of work items to be monitored;
monitoring changes in state of the work items according to a predefined configuration;
storing states of the work items in the associated queues based on the monitoring; and
sending electronic messages to users assigned to the work items based on the states stored in the queues and the predefined configuration.

2. The method of claim 1, wherein the queues comprise Java hashtables.

3. The method of claim 1, wherein the electronic messages are electronic mail messages.

4. The method of claim 1, wherein the predefined configuration sets a schedule for monitoring each of the work items, and a criterion for sending the electronic messages based on the states stored in the queues.

5. The method of claim 1, wherein the works items to be monitored are designated in the predefined configuration according to their assigned user.

6. The method of claim 1, further comprising providing at least one configuration file containing the predefined configuration.

7. The method of claim 1, further comprising creating a message data structure for the electronic messages, wherein the creating step comprises:
providing a name for the message data structure; and
designating data members for the data structure.

8. The method of claim 1, further comprising mapping user identifications to electronic message addresses for the users.

9. The method of claim 1, wherein the work items correspond to computer-based tasks to be completed by the users.

10. A computer-implemented method for monitoring work items, comprising:
associating a queue with each of a set of work lists of work items to be monitored;
designating work items to be monitored by selecting users assigned to the work items;
monitoring changes in state of the work items according to at least one predefined schedule;
storing states of the work items in the associated queues based on the monitoring; and
sending electronic messages to users assigned to the work items based on the states stored in the queues.

11. The method of claim 10, further comprising:
setting the at least one predefined schedule;
creating a message data structure for the electronic messages; and
mapping user identifications to electronic message addresses for the users.

12. The method of claim 10, wherein the queues comprise Java hashtables.

13. The method of claim 10, wherein the electronic messages are electronic mail messages.

14. The method of claim 10, wherein the predefined schedule is stored in at least one configuration file.

15. The method of claim 10, wherein the work items correspond to computer-based tasks to be completed by the users.

16. A system for monitoring work items, comprising:
a queue association system for associating a queue with each of a set of work lists of work items to be monitored;
a user selection system for designating work items to be monitored by selecting users assigned to the work items;
a monitoring system for monitoring changes in state of the work items according to at least one predefined schedule;
a state storage system for storing states of the work items in the associated queues based on the monitoring; and
a messaging system for sending electronic messages to users assigned to the work items based on the states stored in the queues.

17. The system of claim 16, further comprising:
a scheduling system for setting the at least one predefined schedule;
a message data structure system for creating a message data structure for the electronic messages; and
a mapping system for mapping user identifications to electronic message addresses for the users.

18. The system of claim 16, wherein the queues comprise Java hashtables.

19. The system of claim 16, wherein the electronic messages are electronic mail messages.

20. The system of claim 16, wherein the predefined schedule is stored in at least one configuration file.

21. The system of claim 16, wherein the work items correspond to computer-based tasks to be completed by the users.

22. A program product stored on a computer readable medium for monitoring work items, the computer readable medium comprising program code for performing the following steps:
associating a queue with each of a set of work lists of work items to be monitored;
designating work items to be monitored by selecting users assigned to the work items;
monitoring changes in state of the work items according to at least one predefined schedule;
storing states of the work items in the associated queues based on the monitoring; and
sending electronic messages to users assigned to the work items based on the states stored in the queues.

23. The program product of claim 22, wherein the computer readable medium further comprises program code for performing the following steps:
setting the at least one predefined schedule;
creating a message data structure for the electronic messages; and
mapping user identifications to electronic message addresses for the users.

24. The program product of claim 22, wherein the queues comprise Java hashtables.

25. The program product of claim 22, wherein the electronic messages are electronic mail messages.

26. The program product of claim 22, wherein the predefined schedule is stored in at least one configuration file.

27. The program product of claim 22, wherein the work items correspond to computer-based tasks to be completed by the users.

28. A method for deploying an application for monitoring work items, comprising:
providing a computer infrastructure being operable to:
associate a queue with each of a set of work lists of work items to be monitored;
designate work items to be monitored by selecting users assigned to the work items;
monitor changes in state of the work items according to at least one predefined schedule;
store states of the work items in the associated queues based on the monitoring; and
send electronic messages to users assigned to the work items based on the states stored in the queues.

29. The method of claim 28, wherein the computer infrastructure is further operable to:
set the at least one predefined schedule;
create a message data structure for the electronic messages; and
map user identifications to electronic message addresses for the users.
